(19) United States
(12) Patent Application Publication
(10) Pub. No.: US 2009/0196681 A1
(43) Pub. Date: Aug. 6, 2009

(54) JOINT AND/OR BEARING ARRANGEMENT

(76) Inventor: Frank Budde, Steinfeld-Mühlen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/306,359

(22) PCT Filed: Jun. 25, 2007
(86) PCT No.: PCT/DE2007/001116

§ 371 Date: Dec. 23, 2008

(30) Foreign Application Priority Data
Jun. 30, 2006 (DE) 10 2006 030 725.9

(51) Int. Cl. F16C 11/06

(52) U.S. Cl. 403/131

(57) ABSTRACT

A joint and/or bearing arrangement (1) is provided with a joint pin (2), whose head area (3) is mobile in relation to a receiving joint shell (4), and with a gasket (9), which adjoins in the area of a passage opening (6) left for the pin by a housing (5) receiving the joint shell (4) and which is formed with the joint shell (4) into a common one-piece unit. The joint shell (4) is surrounded by a metallic housing (5) and has, in the area of the passage opening (6), a deflector (7) provided with a radially outwardly pointing component for shielding the gasket (9) from the housing (5).

### CROSS REFERENCE TO RELATED APPLICATIONS

This application is a United States National Phase application of International Application PCT/DE2007/001116 and claims the benefit of priority under 35 U.S.C. § 119 of German Patent Application DE 10 2006 030 725.9 filed Jun. 30, 2006, the entire contents of which are incorporated herein by reference.

### FIELD OF THE INVENTION

The present invention pertains to a joint and/or bearing arrangement with a joint pin with a head end mobile in relation to a receiving joint shell with a gasket, a housing receiving the joint shell as well as to a motor vehicle with one or more such joint and/or bearing arrangements, especially the chassis and/or steering parts.

### BACKGROUND OF THE INVENTION

In joint arrangements that have a pin, which is to be held movably with its head area in a joint shell, wherein the joint shell is in turn received in a housing and is secured there against being extracted, the difficulty arises that the interior of the housing with the boundary surfaces must be sealed between the housing and joint shell, on the one hand, and between the joint shell and the head area, on the other hand, in order to thus form a protection against contamination and to prevent lubricant from escaping.

To secure the gasket at the housing, it is known that a straining ring may be used, which extends around the gasket from the outside and presses same against the edge of the housing. Mounting is complicated as a result.

It is known from DE 297 21 050 U1 that the gasket can be made integrally in one piece directly with a flange of the bearing shell. However, since the gasket is made of a soft material with low melting point, it is difficult to mount such joint arrangements, in which the joint shell is directly embedded, for example, extrusion coated, in a housing with a, for example, metallic material, which is at first still liquid and hot during mounting.

### SUMMARY OF THE INVENTION

The basic object of the present invention is to achieve an improvement of the mounting conditions in case of a design with a gasket connected integrally to the joint shell and with metal embedding and/or extrusion coating of the joint shell with an initially hot material.

According to the invention, a joint and/or bearing arrangement is provided comprising: a joint pin with a head area, the pin comprising a vehicle first connection part; a joint shell, the head are a being received in the joint shell and being moveable in relation to the joint shell; a housing formed of a metallic material, the housing receiving the joint shell, the housing and the joint shell having a passage opening for the joint pin, the housing comprising a vehicle second connection part; and a gasket adjoining an area of the passage opening. The gasket is directly connected with the joint shell, and preferably joined to form a common one piece unit with the joint shell. The housing has, in the area of the passage opening a deflector provided with a radially outwardly pointing component for shielding the gasket from the housing, the deflector being formed as an integral part of the joint shell. A separate holding area of the joint shell is located at an axially spaced location from the deflector, for directly joining the gasket with the joint shell.

The present invention also makes it possible to make the gasket directly integrally with the joint shell, to embed the joint shell in a hot material, which is, for example, a metallic material, for example, zinc diecasting, which forms a housing after solidification, without the gasket made integrally in one piece being damaged by the hot material. This gasket is made integrally at a holding area at an axially spaced location from a deflector acting as a heat shield, so that the temperature is markedly reduced there compared to the deflector, which is in contact with the liquid material.

In particular, extrusion coating of the joint shell with the liquid material, which does not obligatorily have to be a metallic material, is considered. However, an inexpensive and stable joint arrangement is made possible by extrusion coating with zinc diecasting.

If at least one deflector is designed as a circumferentially projecting edge, uniformly reliable shielding conditions are created over the circumference by this heat shield.

Just like the gasket, the deflector may also be made in one piece with the joint shell, so that the manufacture of the joint shell and gasket is simple and cost-effective and the good sealing properties are preserved as well.

When the deflector is in contact with the extrusion coat and the gasket, the entry of moisture or particles into the space between the joint shell and the housing can additionally be prevented by the stable deflector.

In particular, it is favorable for this if the gasket is sealingly in contact with the deflector without a gap remaining there. The gasket is advantageously pressed for this by a part of the joint shell, especially the holding area, sealingly against the deflector. This deflector is in turn sealingly in contact with the housing.

A holding area of the joint shell, which [holding area] points outwardly with a radial component, is located at a spaced location—by about 5 mm to 10 mm—from the deflector and behind which the gasket extends axially in the direction of the housing, favorably ensures an intimate and well sealing connection. Moreover, a temperature gradient is ensured by the distance.

The softer gasket may especially favorably also mesh with the undercut of the joint shell or be injected into passage channels of the joint shell at the holding area.

It is favorable for the extrusion coating to provide at least one spacer to avoid full-area contact of the joint head with the extrusion coated joint shell, so that moments of friction and breakaway torques are reduced.

Other advantages and features of the present invention appear from exemplary embodiments of the subject of the present invention, which are shown in the drawings and will be described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic general view of a joint and/or bearing arrangement according to the present invention with a one-piece design of the joint shell and the gasket prepared by injection and with a circumferential deflector between the housing and the gasket, and

FIG. 2 is a view, in direction of arrow II in FIG. 1, of the open side of the joint shell at its holding collar before it is connected to the gasket.

### DESCRIPTION OF THE PREFERRED EMBODIMENTS

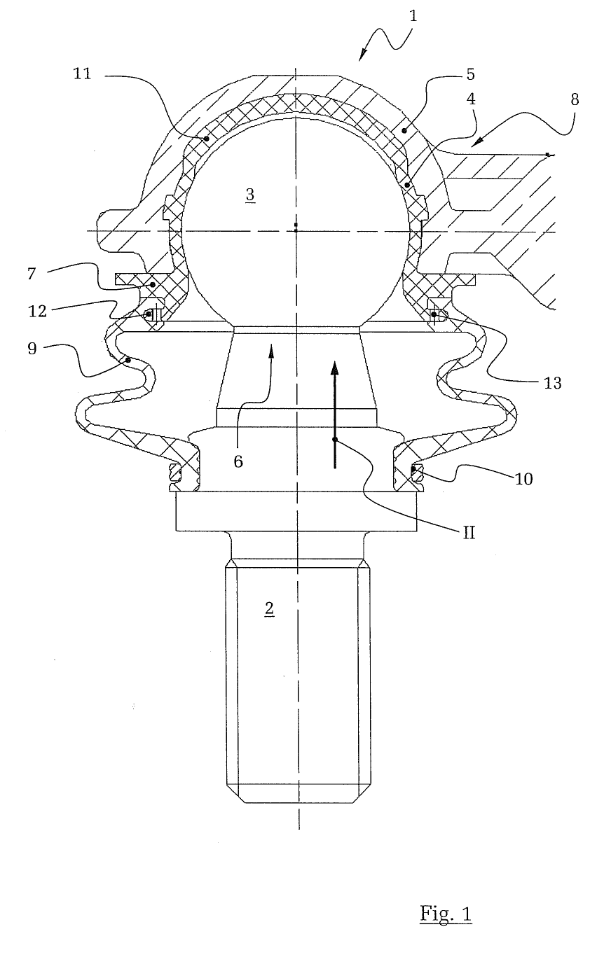

Referring to the drawings in particular, the joint arrangement 1 shown in FIG. 1 comprises an axially extending joint pin 2 with an expanded head area 3, which is formed, for example, by an essentially spherical bulge. This head area 3 can be held movably in and in relation to a usually permanently lubricated joint or bearing shell 4, which is in turn surrounded partially by a housing 5 at least radially on the outside.

For mounting, the joint head 3 is first introduced into the joint shell. Housing 5 is then formed, for example, as an extrusion coating 8 or embedding of the joint shell 4 with the joint head 3 held therein. A liquid, hot material, which is, e.g., metallic as a zinc diecasting, is rigid and dimensionally stable after solidification in a mold and can form a housing 5 made integrally with, for example, an axle carrier or a control arm without further finishing, may be used for such extrusion coating or embedding.

The joint and/or bearing arrangement 1 comprises, furthermore, a gasket 9, frequently designed as a sealing bellows, which adjoins the joint shell 4 at the holding area 12 in the area of the passage opening 6 left by the housing 5 for the pin 2 and made with this joint bearing shell 4 into a common, one-piece unit. For example, the joint shell 4 and the gasket 9 are manufactured in the two-component injection molding process, with which different materials are combined into an integral assembly unit.

The gasket 9 is formed from a soft, elastically deformable material that is soft and elastically deformable compared to the joint shell 4, for example, from a soft polymer material, e.g., chloroprene rubber, natural rubber, thermoplastic elastomer based on polyester, polyurethane or polyolefin.

By contrast, the joint shell 4 may be formed from a PA, POM, PBT, PEEK or crosslinked types of these materials (for example, by electron beam crosslinking). These guarantee the needed temperature resistance and avoid partial melting of the joint shell 4 in contact with the hot material.

The joint shell 4 is already connected integrally to the more sensitive gasket 9 during the extrusion coating or embedding of the joint shell 4 with the hot material.

A deflector 7, which prevents the gasket 9 from coming into contact with the hot material 8 during mounting, is provided according to the present invention. This deflector 7 is designed as a closed, circumferential and radially projecting edge and is made integrally in one piece with the joint shell 4. It is located here such that as a shield, it has direct contact with the extrusion coating 8 on one side, but it is in contact with, but not connected to, the gasket 9 on the other side, which is not compulsory but is favorable for reliable sealing and mechanical stability. Penetration of dirt or moisture into the gap between the housing 5 and the joint shell 4 is reliably prevented hereby from occurring. An additional corrosion protection is unnecessary.

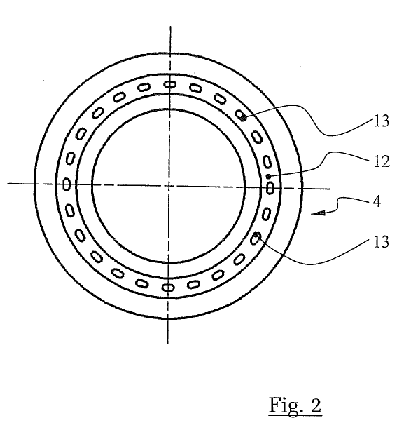

Furthermore, on the other side of the extrusion coating 8 and the deflector 7, a radially outwardly pointing holding area 12, which consists of the same material as the joint shell 4 and is located at an axially spaced location from the deflector 7, is also provided for the mechanical connection proper to the gasket 9. This [holding area] lies here in parallel to the deflector 7 and forms a collar 12, which is surrounded by the sealing bellows 9 axially above and below and is connected to the sealing bellows 9. Due to its prestress, this holding area 12 also brings about an axial pressing of the end of the gasket 9, which end extends behind it, onto the deflector 7. In addition, to achieve good hold of the gasket 9 at the holding area 12—and hence at the joint shell 4—the joint shell 4 may also be provided with a plurality of channels 13 distributed over the circumference, through which the material of the gasket 9 can be injected and intense meshing with the joint shell 4 can be achieved (FIG. 2).

A straining ring 10 may be provided for the gasket 9 at the end located on the other side.

Firm seating of the joint shell 4 in the housing 5 is to be guaranteed to make it possible to absorb the axial and radial forces occurring during operation. On the other hand, the joint head 3 must, however, remain as readily mobile as possible in relation to the joint shell 4, which may be made difficult by the pressure occurring during the extrusion coating and the subsequent solidification of material 8. Nevertheless, to keep the moments of friction and breakaway torques low, at least one spacer 11 may be provided to avoid full-area contact.

Such joint and/or bearing arrangements 1 may be advantageously used in the embodiment according to the present invention especially within chassis and/or steering parts of motor vehicles. The high level of tightness and mobility of the head area 3, while manufacture is at the same time simple due to the integral extrusion coating or embedding, by which the separate pressing of the housing into a control arm or the like is eliminated, are highly advantageous.

While specific embodiments of the invention have been shown and described in detail to illustrate the application of the principles of the invention, it will be understood that the invention may be embodied otherwise without departing from such principles.

1. A joint and/or bearing arrangement comprising:
a joint pin, comprising a head area
a joint shell, said head are a being received in said joint shell and being mobile in relation to said joint shell;
a housing formed of a metallic material, said housing receiving said joint shell, said housing and said joint shell having a passage opening for said joint pin;
a gasket adjoining an area of said passage opening said gasket being formed into a common, one-piece unit with the joint shell, said housing having, in the area of said passage opening, a deflector provided with a radially outwardly pointing component for shielding the gasket from the housing as well as a separate holding area, which is located at an axially spaced location from said deflector, for making the gasket integrally in one piece with the joint shell.

2. A joint and/or bearing arrangement in accordance with claim 1, wherein said housing is formed as an extrusion coating of the joint shell.

3. A joint and/or bearing arrangement in accordance with claim 1, wherein said deflector is designed as a circumferentially projecting edge.

4. A joint and/or bearing arrangement in accordance with claim 1, wherein said deflector is made in one piece with the joint shell.

5. A joint and/or bearing arrangement in accordance with claim 2, wherein said deflector is in contact with the extrusion coating and with the gasket.

6. A joint and/or bearing arrangement in accordance with claim 1, wherein said gasket is sealingly in contact with the deflector.

7. A joint and/or bearing arrangement in accordance with claim 6, wherein said gasket is pressed sealingly onto the deflector for sealing contact of the holding area of the joint shell.

8. A joint and/or bearing arrangement in accordance with claim 7, wherein at the passage opening for the pin, the holding area of the joint shell forms a collar, which points outwardly with a radial component, under which the gasket extends axially in the direction of housing, and is located in parallel to the deflector.

9. A joint and/or bearing arrangement in accordance with claim 1, wherein said gasket meshes with an undercut of the joint shell or is injected into passage channels of the joint shell.

10. A joint and/or bearing arrangement in accordance with claim 1, wherein the gasket is formed from a material that is soft and elastically deformable compared to the joint shell.

11. A joint and/or bearing arrangement in accordance with claim 10, wherein said joint shell is provided with at least one spacer for avoiding a full-area contact between the joint head and the joint shell.

12. (canceled)

13. A motor vehicle, comprising:
a joint and/or bearing arrangement comprising a joint pin with a head area, a joint shell, said head are a being received in said joint shell and being moveable in relation to said joint shell, a housing formed of a metallic material, said housing receiving said joint shell, said housing and said joint shell having a passage opening for said joint pin, a gasket adjoining an area of said passage opening, said gasket being directly connected with said joint shell, said housing having, in the area of said passage opening, a deflector provided with a radially outwardly pointing component for shielding said gasket from said housing as well as a separate holding area, which is located at an axially spaced location from said deflector, for directly joining said gasket with said joint shell, wherein said pin comprises a vehicle first connection part and said housing comprises a vehicle second connection part.

14. A motor vehicle according to claim 13, wherein said pin comprises a first chassis/steering part connection part and said joint or bearing arrangement housing comprises a second chassis/steering part connection part and wherein said gasket is directly connected with said joint shell by forming said gasket and said bearing shell in a two-component injection molding process, with which different materials are combined into an integral assembly unit.

15. A joint and/or bearing arrangement comprising:
a joint pin with a head area, said pin comprising a vehicle first connection part;
a joint shell, said head are a being received in said joint shell and being moveable in relation to said joint shell;
a housing formed of a metallic material, said housing receiving said joint shell, said housing and said joint shell having a passage opening for said joint pin, said housing comprising a vehicle second connection part;
a gasket adjoining an area of said passage opening, said gasket being directly joined with said joint shell, said housing having, in the area of said passage opening;
a deflector provided with a radially outwardly pointing component for shielding said gasket from said housing, said deflector being formed as an integral part of said joint shell; and
a separate holding area of the joint shell, said holding area being located at an axially spaced location from said deflector, for directly joining said gasket with said joint shell.

16. A joint and/or bearing arrangement in accordance with claim 15 wherein said housing comprises an extrusion coating of said joint shell.

17. A joint and/or bearing arrangement in accordance with claim 15, wherein said deflector is designed as a circumferentially projecting edge and said gasket is directly joined with said joint shell by forming said gasket and said bearing shell in a two-component injection molding process, with which different materials are combined into an integral assembly unit.

18. A joint and/or bearing arrangement in accordance with claim 17, wherein said deflector is made in one piece with the joint shell.

19. A joint and/or bearing arrangement in accordance with claim 18, wherein said deflector is in contact with said extrusion coating and with said gasket.

20. A joint and/or bearing arrangement in accordance with claim 18, wherein said gasket is sealingly in contact with said deflector, wherein said gasket is pressed sealingly onto said deflector for sealing contact of said holding area of the joint shell.

21. A joint and/or bearing arrangement in accordance with claim 20, wherein at the passage opening for the pin, the holding area of the joint shell forms a collar, which points outwardly with a radial component, under which the gasket extends axially in the direction of housing, and is located in parallel to the deflector.
